(19) United States
(12) Patent Application Publication
(10) Pub. No.: US 2026/0209018 A1
(43) Pub. Date: Jul. 23, 2026

(54) AERIAL LIFT FOR PERSONS WORKING AT HEIGHT

(71) Applicant: MANITOU BF, ANCENIS (FR)

(72) Inventors: Cédric HUREL, ANCENIS (FR); Jérôme ROUSSEAU, ANCENIS (FR); Stéphane OGER, ANCENIS (FR)

(21) Appl. No.: 19/140,583

(22) PCT Filed: Jan. 2, 2024
(86) PCT No.: PCT/FR2024/050004

§ 371 Date: Jun. 18, 2025

(30) Foreign Application Priority Data
Jan. 4, 2023 (FR) 2300050

(51) Int. Cl. B66F 17/00; B66F 11/04

(52) U.S. Cl. CPC B66F 17/006; B66F 11/044

(57) ABSTRACT

The invention relates to an aerial lift (1) comprising a self-propelled chassis (3), a basket (2) with a manual control (7) for driving the movement of the chassis (3) along the ground, an arm (4) for lifting the basket (2), a sensor (5) for sensing the position of the arm (4), a device (8) for emitting a warning signal, a control unit (6), and a working configuration operating mode and a transport configuration operating mode each defined by a maximum speed of movement of the chassis (3) and each selectively activatable depending on the position of the arm (4). The aerial lift (1) comprises a shake sensor (9) and a so-called anti-roll sensor (10). The control unit (6) is configured such that, in the working configuration operating mode, it controls an inactivation of the controls (7) for moving the chassis along the ground according to the data supplied by the anti-roll sensor (10). The control unit (6) is configured such that, in the transport configuration operating mode, it controls the device (8) for emitting a warning signal according to the data provided by the shake sensor (9), and the shake sensor (9) and the anti-roll sensor (10) are formed by one and the same three-axis accelerometer arranged on the chassis (3).

The present invention relates to an aerial lift for persons working at height.

The invention relates in particular to an aerial lift for persons working at height, said aerial lift comprising a self-propelled chassis, a basket equipped with at least one manually operable control for driving the self-propelled chassis along the ground, a pivoting arm for at least raising and lowering the basket, mounted movably between an extreme low position close to the ground and an extreme high position away from the ground, a sensor for determining the position of the arm, a device for emitting an audible and/or luminous warning signal, a control unit, this aerial lift having at least one working configuration operating mode and one transport configuration operating mode, each defined at least by a maximum movement speed of the self-propelled chassis, the control unit being configured to activate either of the operating modes according to the data provided by the sensor for determining the position of the arm.

Such an aerial lift is known, as illustrated in document WO2018/229381.

Document US2012/211301 describes an aerial lift comprising an accelerometer to determine the state of movement of the platform. Similarly, document US2020/317486 describes an aerial lift incorporating an accelerometer.

Such aerial lifts create numerous situations where there is a risk of accident. Manufacturers of such aerial lifts are therefore looking for solutions that make it possible to simply identify situations where there is a risk of accident.

For this purpose, the invention relates to an aerial lift for persons working at height, said aerial lift comprising a self-propelled chassis, a basket equipped with at least one manually operable control for driving the self-propelled chassis along the ground, a pivoting arm for at least raising and lowering the basket, mounted movably between an extreme low position close to the ground and an extreme high position away from the ground, a sensor for determining the position of the arm, a device for emitting an audible and/or luminous warning signal, a control unit, this aerial lift having at least one working configuration operating mode and one transport configuration operating mode, each defined at least by a maximum movement speed of the self-propelled chassis, the control unit being configured to activate either of the operating modes according to the data provided by the sensor for determining the position of the arm, characterized in that the aerial lift comprises a sensor for determining a parameter representing a shock affecting the basket, referred to as a shock sensor, and an anti-roll sensor for determining a parameter representing the inclination of the chassis with respect to the horizontal, in that the control unit is configured, in the working configuration operating mode, to deactivate the control or controls for driving the self-propelled chassis along the ground according to the data supplied by the anti-roll sensor, in that the control unit is configured, in the transport configuration operating mode, to control the device for emitting an audible and/or luminous warning signal according to the data provided by the shock sensor, and in that the shock sensor and the anti-roll sensor are formed by one and the same sensor in the form of a three-axis accelerometer arranged on the self-propelled chassis. The choice of a sensor in the form of an accelerometer with at least three axes arranged on the chassis allows this sensor to be used as a device for measuring acceleration along at least the axis Z in the transport configuration operating mode to detect shocks affecting the basket and encourage the driver of the aerial lift to reduce speed, and as an inclination sensor in the working configuration operating mode to detect a dangerous inclination of the chassis with respect to the horizontal and to at least prevent the machine from being commanded to move forward from the basket when the inclination of the chassis is too great. This simplifies the aerial lift. It should be noted that the term “shock” describes an undesired movement of the basket which may be at least an oscillating movement in the direction Z.

According to one embodiment of the invention, the aerial lift comprises a memory for storing data on at least one acceleration threshold value, and in that the control unit is configured, in the transport configuration operating mode, to compare the acceleration values measured by the shock sensor with said acceleration threshold value or values and to control the device for emitting an audible and/or luminous warning signal according to the result of the comparison. The control unit is in particular configured to command, in the transport configuration, the emitting device to emit an audible and/or luminous warning signal when the acceleration value along Z measured by the shock sensor is greater than the, or at least one of the, stored acceleration threshold values. The driver of the machine is thus warned that they are driving in a dangerous manner.

According to one embodiment of the invention, the aerial lift comprises a memory for storing data on at least one threshold value for the inclination angle of the chassis with respect to the horizontal and the control unit is configured, in the working configuration operating mode, to calculate the inclination angle value of the chassis using values measured by the anti-roll sensor and to compare the calculated value with the inclination angle threshold value or values and to deactivate the control or controls for driving the self-propelled chassis along the ground according to the result of the comparison. The control unit is in particular configured to prevent movement of the self-propelled chassis along the ground in the working configuration, if the value of the inclination angle of the chassis with respect to the horizontal determined using the data supplied by the anti-roll sensor is greater than the stored inclination angle threshold value or values.

According to one embodiment of the invention, the control unit is configured, in the working configuration operating mode, to control the device for emitting an audible and/or luminous warning signal according to the results of the comparison. The control unit may, in the working configuration and in addition to preventing the self-propelled chassis from moving along the ground, command the emission of an audible and/or luminous warning signal.

According to one embodiment of the invention, the aerial lift comprises, in at least one of the operating modes, a counter for the number of times the threshold value or at least one threshold value is exceeded. This data is used to provide information on the risks taken by the driver of the aerial lift.

According to one embodiment of the invention, the control unit is configured, at least in the transport configuration operating mode, to control the device for emitting an audible and/or luminous warning signal according to the data supplied by the counter for the number of times the threshold value or at least one threshold value is exceeded. The control unit is configured, in the transport configuration, to vary the warning signal according to the number of times the threshold value or at least one threshold value is exceeded and for example the duration and/or frequency thereof. In this embodiment, the aerial lift can therefore comprise a timer and a data storage memory, and the control unit is configured to control, in parallel with the storage of the data provided by the counter of the number of times the or at least one value has been exceeded, the storage of data provided by the timer. The control unit can thus process these data to vary the warning signal according to the result of the processing.

According to one embodiment of the invention, the aerial lift comprises at least one geolocation device and a memory for storing position data from the geolocation device, and the control unit is configured, in at least one operating mode, to command at least one storage of said position data according to the data provided by the shock sensor or the anti-roll sensor. The control unit can thus control the storage of the position data, in at least one of the operating modes, if an inclination or acceleration threshold value is exceeded on at least one occasion. The data can then for example be processed, in the working configuration, to provide the driver of the aerial lift, on a display device, with risk zones resulting for example from the irregular profile of the road on which said self-propelled chassis is driving. This enables the driver of the aerial lift to adapt their driving in these risk areas.

According to one embodiment of the invention, the aerial lift comprises a radio link communication device capable of transmitting data by radio link, and the control unit is configured to control the communication device to enable data transmission. All the stored data can, before or after processing, be sent to a remote terminal.

According to one embodiment of the invention, the control unit is configured to activate the transport configuration operating mode when the arm is in the extreme low position.

According to one embodiment of the invention, the maximum movement speed of the self-propelled chassis in the working configuration operating mode is lower than the maximum movement speed of the self-propelled chassis in the transport configuration operating mode.

According to one embodiment of the invention, the device for emitting an audible and/or luminous warning signal comprises at least one lighting device and/or a display device and/or at least one audible alarm, and at least one part of the device for emitting an audible and/or luminous warning signal is preferably arranged on the basket. The various forms that the device for emitting an audible and/or luminous warning signal can take make it possible to adapt the form and intensity of the signal easily to the driving conditions.

### SHORT DESCRIPTION OF THE DRAWINGS

The invention will be clearly understood on reading the following description of exemplary embodiments, with reference to the appended drawings, in which:

FIG. 1 is a perspective view of an aerial lift according to the invention in the working configuration operating mode corresponding to a position other than the extreme low position of the arm;

FIG. 2 schematically shows the inputs and outputs of the control unit;

FIG. 3 is a perspective view of an aerial lift according to the invention in the transport configuration operating mode corresponding to the extreme low position of the arm;

FIG. 4 is a view of the basket with details of the device for emitting a warning signal;

FIG. 5 is a schematic view of the inclination angles in a reference frame X, Y, Z to illustrate the link between acceleration measurement and determination of inclination angle.

As mentioned above, the invention relates to an aerial lift 1 for persons working at height. This aerial lift 1 comprises a self-propelled chassis 3 and a basket 2 equipped with at least one control 7 for driving the self-propelled chassis 3 along the ground. This control 7 is manually actuated. The aerial lift 1 also comprises a pivoting arm 4 for at least raising or lowering the basket 2. This arm 4 is mounted movably between an extreme low position close to the ground and an extreme high position away from the ground. The aerial lift 1 comprises a sensor 5 for determining the position of the arm 4 and a device 8 for emitting an audible and/or luminous warning signal. The aerial lift 1 also comprises a control unit 6.

The basket 2 has a platform having a location for accommodating an operator. This working platform is in this case formed by a floor and a guard rail surrounding the floor while allowing access to the interior of said platform. The operator is usually standing inside the accommodation location of the platform and faces a control console carried by the platform. This control console is usually arranged at a distance from the floor of the platform along the guard rail of the platform. This control console is equipped with at least one, and preferably several, manually operated controls, such as buttons, levers or the like. These controls comprise the control or controls 7 of the means for driving the motorized self-propelled chassis 3 along the ground. The basket 2 is also equipped with controls for raising and lowering the basket 2. These commands are described in greater detail below.

In this context, a self-propelled chassis 3 is understood to mean a chassis equipped with means for driving the chassis 3 along the surface of the ground. These means for moving the chassis 3 along the surface of the ground on wheels or tracks comprise at least one motor and a transmission of the rotational movement of the drive shaft of the motor to the wheels or tracks. The details of such a transmission are not provided because such a transmission is well known to a person skilled in the art. The chassis 3 is therefore a motorized chassis equipped with wheels and/or tracks.

The aerial lift also comprises means for raising the basket 2 with respect to the chassis 3, which in this case comprise a pivoting arm 4, these raising means being arranged between a zone for connection to the basket 2 and the chassis 3. This lifting arm 4 may be formed by one or more arm sections articulated to one another, as in the example shown. This arm 4 may also be a telescopic or non-telescopic arm. To switch the arm from the low position to the high position, the aerial lift may comprise a hydraulic pump coupled for example to the heat engine of the ground movement means and at least one hydraulic actuator, in this case, at least one cylinder arranged between the arm 4 and the chassis 3 and several actuators arranged between the arm sections when the arm is made of different sections.

The or each cylinder is supplied with hydraulic fluid by means of the hydraulic pump. Again, details of this operation are not provided, as it is well known to a person skilled in the art. The arm 4 is pivotingly coupled to the chassis 3 by a pivoting connection. This pivoting connection is a pivoting connection about a horizontal axis when the aerial lift 1 is in the positioned state on a horizontal flat surface. This arm 4, which enables the basket 2 to be raised and lowered, is therefore, at least by this pivoting connection, mounted movably between an extreme low position close to the ground and an extreme high position away from the ground.

To determine the position of the arm 4, the aerial lift 1 comprises a sensor 5 for determining the position of the arm 4. This sensor 5 is used at least to detect the extreme low position of the arm 4, and can for example be formed by a simple contactor activated when the arm 4 is in the extreme low position. This sensor 5 for determining the position of the arm 4 may also be formed by a sensor for detecting the angular position of the arm, in particular the section of the arm pivotingly coupled to the chassis in the case of an arm 4 with several arm sections. The term “extreme low position” is therefore understood here to mean that at least the part of the arm 4 closest to the chassis 3 is in a position in which the sensor 5 for determining the position of the arm 4 is detecting that the arm 4 is in said position or that the arm is entering or leaving this position.

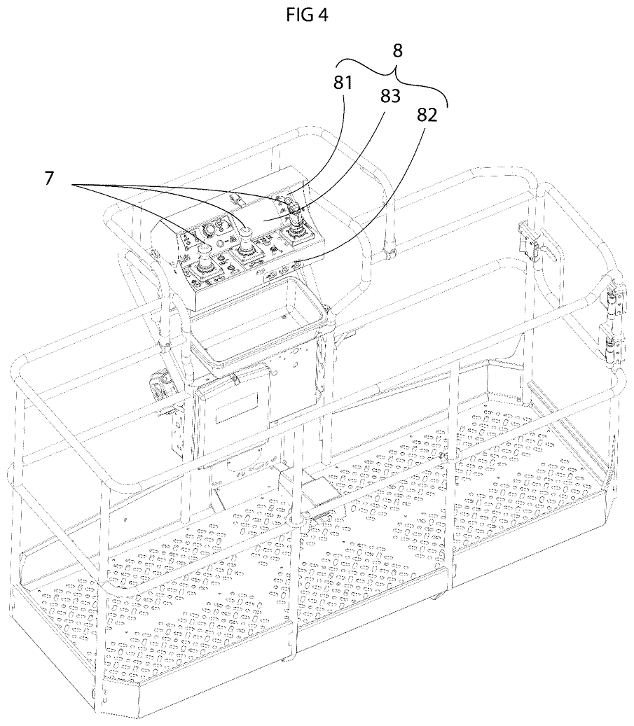

The aerial lift 1 comprises, as mentioned above, controls for said aerial lift 1. To this end, the basket 2 may be equipped with a control console, for example comprising one or more levers, also known as joysticks. For example, a first lever may be provided for actuating the lifting of the lifting arm, a second lever for the forward/reverse control of the traveling chassis and, in the case where the arm is mounted on a pivoting turret of the chassis, a third lever for controlling the rotation of the turret, as shown in FIG. 4. All the movements of these levers can be measured by transducers and supplied in the form of electrical signals to the control unit 6, which is described below. In this embodiment, the second lever is the control 7 for moving the chassis 3 along the ground.

As mentioned above, the aerial lift also comprises a control unit 6. Said control unit is an electronic IT system that for example comprises a microprocessor and a working memory. According to a specific aspect, the control unit can be a PLC.

In other words, the functions and steps described may be implemented in the form of a computer program or via hardware components (for example programmable gate arrays). In particular, the functions and steps performed by the control unit 6 or the modules thereof may be performed by sets of instructions or computer modules implemented in a processor or controller or may be performed by dedicated electronic components or programmable logic circuit components (or FPGA standing for field-programmable gate array) or the application-specific integrated circuit (ASIC) components. It is also possible to combine computer parts and electronic parts.

When it is specified that the control unit 6 or means or modules of said unit are configured to perform a given operation, this means that the control unit 6 comprises computer instructions and the corresponding means of execution to allow said operation to be performed and/or that the control unit 6 comprises corresponding electronic components.

This control unit 6 is able to receive input data and to deliver output data. This control unit 6 is configured to control the lifting means and in particular the movement of the arm as well as the means for moving the self-propelled chassis along the ground according to the data supplied by the controls, which are positioned in the basket. The aerial lift 1 may comprise, in addition to the controls arranged in the basket, a control station mounted on the chassis 3 and referred to as a ground control station. This ground control station is used to assist an operator in difficulty in the basket 2 and to carry out operations on the aerial lift 1 without having to climb into the basket 2.

The aerial lift 1 also comprises, as mentioned above, a device 8 for emitting an audible and/or luminous warning signal, at least a part of which may be arranged in the basket, in particular on the control console, as described above.

This device 8 for emitting an audible and/or luminous warning signal comprises at least one lighting device 81 and/or a display device 83 and/or at least one audible alarm 82. The lighting device 81 may take the form of a rotating beacon, for example. The display device 83 may comprise at least one display screen. The alarm 82 can be formed by a siren emitting a continuous or discontinuous audible signal.

The aerial lift 1 also has at least one working configuration operating mode and one transport configuration operating mode, each defined at least by a maximum movement speed of the self-propelled chassis 3. The maximum movement speed of the self-propelled chassis 3 in the working configuration operating mode is lower than the maximum movement speed of the self-propelled chassis 3 in the transport configuration operating mode. Thus, when the control 7 for moving the self-propelled chassis 3 along the ground is in a position corresponding to the maximum movement speed, for example when the chassis 3 is in forward gear, the maximum movement speed of the chassis 3 is a function of an operating mode of the aerial lift. By way of example, this maximum movement speed is of the order of 0.7 km/h in the working configuration operating mode and of the order of 5 km/h in the transport configuration operating mode.

The control unit 6 is configured to activate one or the other of the operating modes according to the data supplied by the sensor 5 for determining the position of the arm 4. In particular, the control unit 6 is configured to activate the transport configuration operating mode when the arm 4 is in the extreme low position. Thus, as soon as the sensor 5 for determining the position of the arm 4 detects that the arm is in the extreme low position, data from the sensor 5 for determining the position of the arm 4 are sent to the control unit 6 and the transport configuration operating mode is activated. It should be noted that in the case of a telescopic arm, the transport configuration of the aerial lift corresponds, in addition to the lowered position of the arm, to the retracted position of the telescope.

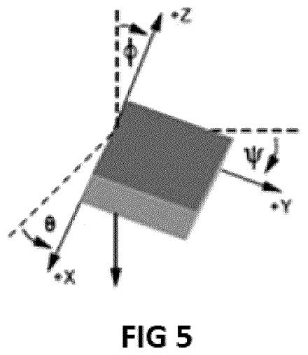

The aerial lift 1 also comprises a sensor for determining a parameter representing a shock affecting the basket 2 referred to as a shock sensor and denoted with reference sign 9 in the figures, as well as a sensor referred to as an anti-roll sensor, denoted with reference sign 10 in the figures. The so-called anti-roll sensor 10 is a sensor for determining a parameter representing the inclination of the chassis 3 with respect to the horizontal. The shock sensor 9 and the anti-roll sensor 10 are formed by one and the same sensor in the form of a three-axis accelerometer arranged on the self-propelled chassis 3. Indeed, acceleration measurements can be used to calculate the inclination angle values of the structure carrying said accelerometer, as illustrated by the formulae below associated with FIG. 5.

$$θ = {tan}^{- 1} ( \frac{{A}_{X}}{\sqrt{{A}_{Y}^{2} + {A}_{Z}^{2}}} ) \qquad [ Math 1 ]$$

$$ψ = {tan}^{- 1} ( \frac{{A}_{Y}}{\sqrt{{A}_{X}^{2} + {A}_{Z}^{2}}} )$$

$$ϕ = {tan}^{- 1} ( \frac{\sqrt{{A}_{X}^{2} + {A}_{Y}^{2}}}{{A}_{Z}} )$$

Acceleration A is expressed in ms⁻².

Each angle is expressed in degrees.

The positioning of this accelerometer on the chassis makes it possible to determine the inclination of the chassis 3 with respect to the horizontal while providing an image along the axis Z of the shocks affecting the basket 2. In fact, the shocks affecting the basket 2 are considered to correspond to the shocks affecting the chassis, to within a multiplicative factor. This simplifies the aerial lift.

In the working configuration operating mode, the control unit 6 is configured to deactivate the control or controls 7 for driving the self-propelled chassis along the ground according to the data supplied by the anti-roll sensor 10. In practice, the aerial lift 1 comprises a memory 12 for storing data on at least one threshold inclination value of the chassis 3 with respect to the horizontal and the control unit 6 is configured, in the working configuration operating mode, to calculate the inclination angle value of the chassis 3 with respect to the horizontal, i.e. with respect to Y, from the acceleration values measured by the anti-roll sensor 10 as shown above.

The control unit 6 is also configured to compare the calculated value with the stored threshold inclination value or values and to deactivate the control or controls 7 for moving the self-propelled chassis 3 along the ground according to the result of the comparison. In general, the threshold inclination value with respect to the horizontal of the chassis 3 is close to 4° or 5°. Deactivating the control or controls 7 for driving the chassis 3 along the ground means that an action by the operator in the basket 2 on the control or controls 7 for driving the chassis 3 along the ground has no effect on the driving of the chassis 3 along the ground. It is of little importance that this deactivation for example results from the movements or signals of the control or controls 7 for moving the chassis along the ground not being transmitted to the control unit 6, or from the control unit 6 for controlling the movements or signals ignoring the control or controls 7 for moving the chassis 3 along the ground.

In the transport configuration operating mode, i.e. with the arm 4 in the extreme low position detected by the sensor 5 for determining the position of the arm, the control unit 6 is configured to control at least the device 8 for emitting an audible and/or luminous warning signal according to the data supplied by the shock sensor 9. This shock sensor 9 therefore measures an acceleration along the axis Z of the chassis 3. This measurement of acceleration along the axis Z of the chassis 3 is considered to represent the shocks affecting the operator in the basket 2.

In practice, the aerial lift 1 comprises a memory 11 for storing data on at least one acceleration threshold value along Z and the control unit 6 is configured, in a transport configuration operating mode, to compare the acceleration value measured by the shock sensor 9 with said threshold value or values and to control the device 8 for emitting an audible and/or luminous warning signal according to the result of the comparison. Each acceleration value measured by the shock sensor 9 is an acceleration value measured along the axis Z. Although the shock sensor 9 is on the chassis 3, each acceleration value along the axis Z supplied is an excellent image of the shocks affecting the basket 2. Generally, the acceleration threshold value along Z is of the order of 1.5 g, i.e. about 15 m/s².

In transport configuration operating mode, warning signals can be emitted in a wide variety of forms. Thus, if the acceleration threshold value is exceeded, the excess value and the ground movement speed of the aerial lift can both be taken into account. Depending on the amplitude of the shock, with the risk of a violent shock ejecting the operator from the basket 2, the warning can vary, and for example take the form in the least problematic situations (low shock) of an image displayed of the control console, on the display device 83, such as a screen, equipping the control panel of the basket. If the risk increases, an indicator light in the form of a flashing light integrated into a lighting device 81 arranged in the basket can be activated. Finally, a display on the display device 83 combined with the emission of an audible signal by virtue of the presence of an audible alarm 82 in the basket can be considered. A display may also be provided on the display device fitted to the chassis 3. Of course, these examples of emitting a warning signal can be combined or modified without departing from the scope of the invention.

In the working configuration operating mode, the control unit 6 may, in addition to deactivating the control or controls 7 for driving the self-propelled chassis 3 along the ground, control the device 8 for emitting an audible and/or luminous warning signal according to the result of the comparison between the value of the inclination angle of the chassis with respect to the horizontal determined using acceleration values measured by the anti-roll sensor 10 and the stored inclination angle threshold value or values. If the threshold value for the inclination angle is exceeded, the warning signal may vary according to the inclination and the risk involved, in the same way as described above with reference to shocks of variable amplitude.

The aerial lift may comprise a counter 13 for the number of times the threshold value or at least one of the threshold values is exceeded. This exceedance counter 13 can be active in at least one of the operating modes, preferably in every operating mode of the aerial lift 1. This exceedance counter 13 is used to monitor the use of the aerial lift 1. This exceedance counter 13 can be incremented each time a threshold value is exceeded or after a predetermined number of exceedances, or else according to the value of the exceedance. Similarly, the device 8 for emitting an audible and/or luminous warning signal can be controlled according to the data supplied by the counter 13 for the number of times the threshold value or at least one threshold value is exceeded in an operating mode. This number of exceedances can also be quantified over time, to provide an image of the stresses affecting the aerial lift. Again, it can be concluded that the aerial lift is heavily stressed if the number of times the threshold value is exceeded, for example per week, in particular in the transport configuration operating mode, is high. To this end, the aerial lift may comprise a timer 14 which may be formed at least partially by a clock and a memory 15 for storing the number of times a threshold value is exceeded per unit of time.

In order to complete the monitoring of the use of the aerial lift and to best warn the driver of the aerial lift 1, the aerial lift 1 comprises at least one geolocation device 16 and a memory 17 for storing position data from the geolocation device 16. The control unit 6 is configured, in at least one operating mode, to command at least one storage of said position data according to the data provided by the shock sensor 9 or the anti-roll sensor 10. Thus, the control unit 6 can be configured to store the position data corresponding to the location where the threshold value is exceeded each time a threshold value is exceeded in at least one of the operating modes. This makes it possible to identify risk areas which can be subsequently displayed, for example, on the control console in the basket, to warn the driver of the aerial lift of a danger on the road, such as a hole or the like.

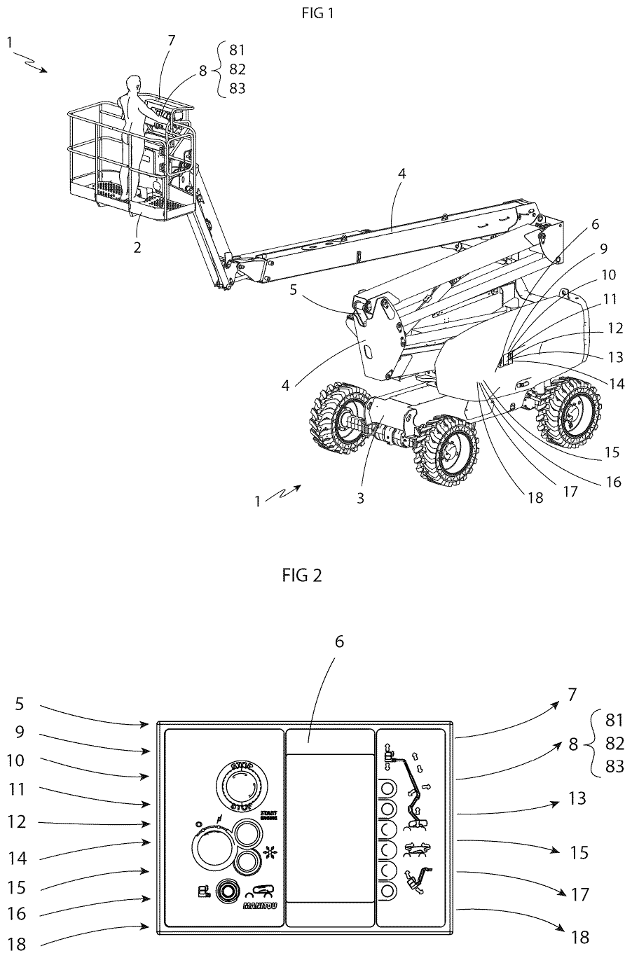

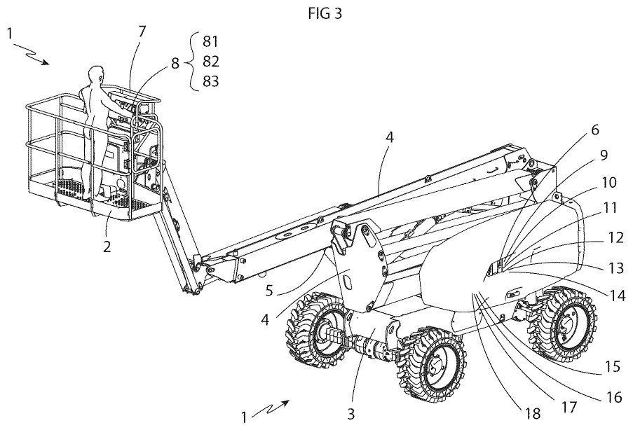

With regard to the foregoing and as illustrated in FIG. 2, the control unit 6 is capable of receiving input data which may in particular be either logic information for lifting, movement or the like, or measurements coming from the sensors, and of emitting output data which may be control instructions, guidance information, these input and output data being dependent on the operating mode of the aerial lift 1.

Input data may be derived from a communication from outside the aerial lift, in particular with a remote terminal.

Similarly, the output data can be transferred to a remote terminal. To this end, the aerial lift 1 comprises a radio link communication device 18 capable of transmitting data by radio link, and the control unit 6 is configured to control the communication device 18 to enable data transmission. This radio link communication device 18 is conventionally formed by known transmitters/receivers. It is therefore not described in detail.

In practice, the operation of an aerial lift as described above is as follows. The aerial lift 1 is by default in the transport configuration operating mode because the arm 4 is usually in the extreme low position at the time the aerial lift 1 is started. The operator takes their place in the basket 2 to control the movement of the chassis 3 along the ground and the lifting of the basket 2 from said basket 2. As soon as the operator commands the arm 4 to be raised from the basket, this being detected by the sensor 5 for determining the position of the arm 4, the aerial lift 1 switches to the working configuration operating mode. In this working configuration operating mode, as soon as the control unit 6 determines, from the data supplied by the anti-roll sensor 10, an inclination of the chassis 3 with respect to the horizontal greater than a stored threshold value, it deactivates the control or controls 7 for driving the chassis 3 along the ground to prevent the aerial lift from overturning.

If the control or controls 7 for driving the chassis 3 along the ground have been disabled, the driver of the aerial lift has to command the arm in a lowering of the arm 4 to return to the transport configuration operating mode, thereby enabling the chassis 3 to be moved to a new position in which the inclination is not critical. In the transport configuration operating mode, the control unit 6 emits a warning signal when the shock sensor 9, which measures an acceleration only along Z of the chassis, supplies an acceleration value greater than a predetermined acceleration threshold value along Z, thus informing the operator of the risk of shocks which could eject the operator from the basket if the operator in the basket does not reduce the speed of the aerial lift 1.

Obviously, in the transport configuration operating mode, a warning can also be emitted when the inclination of the chassis 3 with respect to the horizontal is greater than a stored threshold value, however, exceeding this threshold value has no effect on the movement of the chassis 3 along the ground.

1. An aerial lift (1) for persons working at height, said aerial lift (1) comprising a self-propelled chassis (3), a basket (2) equipped with at least one manually operable control (7) for driving the self-propelled chassis (3) along the ground, a pivoting arm (4) for at least raising and lowering the basket (2), mounted movably between an extreme low position close to the ground and an extreme high position away from the ground, a sensor (5) for determining the position of the arm (4), a device (8) for emitting an audible and/or luminous warning signal, a control unit (6), this aerial lift (1) having at least one working configuration operating mode and one transport configuration operating mode, each defined at least by a maximum movement speed of the self-propelled chassis (3), the control unit (6) being configured to activate either of the operating modes according to the data provided by the sensor (5) for determining the position of the arm (4), characterized in that the aerial lift (1) comprises a sensor for determining a parameter representing a shock affecting the basket (2), referred to as a shock sensor (9), and a so-called anti-roll sensor (10) for determining a parameter representing the inclination of the chassis (3) with respect to the horizontal, in that the control unit (6) is configured, in the working configuration operating mode, to deactivate the control or controls (7) for driving the self-propelled chassis along the ground according to the data supplied by the anti-roll sensor (10), in that the control unit (6) is configured, in the transport configuration operating mode, to control the device (8) for emitting an audible and/or luminous warning signal according to the data provided by the shock sensor (9), and in that the shock sensor (9) and the anti-roll sensor (10) are formed by one and the same sensor in the form of a three-axis accelerometer arranged on the self-propelled chassis (3).

2. The aerial lift (1) as claimed in claim 1, characterized in that the aerial lift (1) comprises a memory (11) for storing data on at least one acceleration threshold value, and in that the control unit (6) is configured, in the transport configuration operating mode, to compare the acceleration values measured by the shock sensor (9) with said acceleration threshold value or values and to control the device (8) for emitting an audible and/or luminous warning signal according to the result of the comparison.

3. The aerial lift (1) as claimed in either of claims 1 and 2, characterized in that the aerial lift (1) comprises a memory (12) for storing data on at least one threshold value for the inclination angle of the chassis (3) with respect to the horizontal and in that the control unit (6) is configured, in the working configuration operating mode, to calculate the inclination angle value of the chassis (3) using values measured by the anti-roll sensor (10) and to compare the calculated value with the inclination angle threshold value or values and to deactivate the control or controls (7) for driving the self-propelled chassis (3) along the ground according to the result of the comparison.

4. The aerial lift (1) as claimed in claim 3, characterized in that the control unit (6) is configured, in the working configuration operating mode, to control the device (8) for emitting an audible and/or luminous warning signal according to the result of the comparison.

5. The aerial lift (1) as claimed in one of claims 2 to 4, characterized in that said aerial lift (1) comprises, in at least one of the operating modes, a counter (13) for the number of times the threshold value or at least one threshold value is exceeded.

6. The aerial lift (1) as claimed in claim 5, characterized in that the control unit (6) is configured, at least in the transport configuration operating mode, to control the device (8) for emitting an audible and/or luminous warning signal according to the data supplied by the counter (13) for the number of times the threshold value or at least one threshold value is exceeded.

7. The aerial lift (1) as claimed in one of claims 1 to 6, characterized in that the aerial lift (1) comprises at least one geolocation device (16) and a memory (17) for storing position data from the geolocation device (16), and in that the control unit (6) is configured, in at least one operating mode, to command at least one storage of said position data according to the data provided by the shock sensor (9) or the anti-roll sensor.

8. The aerial lift (1) as claimed in one of claims 1 to 7, characterized in that said aerial lift (1) comprises a radio link communication device (18) capable of transmitting data by radio link, and in that the control unit (6) is configured to control the communication device (18) to enable data transmission.

9. The aerial lift (1) as claimed in one of claims 1 to 8, characterized in that the control unit (6) is configured to activate the transport configuration operating mode when the arm (4) is in the extreme low position.

10. The aerial lift (1) as claimed in one of claims 1 to 9, characterized in that the maximum movement speed of the self-propelled chassis (3) in the working configuration operating mode is lower than the maximum movement speed of the self-propelled chassis (3) in the transport configuration operating mode.

11. The aerial lift (1) as claimed in one of claims 1 to 10, characterized in that the device (8) for emitting an audible and/or luminous warning signal comprises at least one lighting device (81) and/or a display device (83) and/or at least one audible alarm (82), and in that at least one part of the device (8) for emitting an audible and/or luminous warning signal is preferably arranged on the basket (2).
